(19) United States
(12) Patent Application Publication
(10) Pub. No.: US 2024/0311461 A1
(43) Pub. Date: Sep. 19, 2024

(54) SYSTEM AND METHOD FOR CARD EMULATION ON A WEARABLE DEVICE

(71) Applicant: Capital One Services, LLC, McLean, VA (US)

(72) Inventors: Colin HART, Washington, DC (US); Lea CODY, Arlington, VA (US); Kaitlin NEWMAN, Washington, DC (US); Jeffrey RULE, Chevy Chase, MD (US)

(21) Appl. No.: 18/121,462

(22) Filed: Mar. 14, 2023

(51) Int. Cl. G06F 21/34

(52) U.S. Cl. CPC G06F 21/34

(57) ABSTRACT

Systems and methods for card emulation on wearables devices are provided. Exemplary systems include a contactless card and a wearable device. A communication field can open between the contactless card and the wearable device. The wearable device can receive data from the contactless card. The wearable device can emulate an applet of the contactless card, allowing the wearable device to use the applet information to complete transactions that would otherwise require the contactless card.

### FIELD OF DISCLOSURE

The present disclosure relates to systems and methods for the use of a contactless card when interacting with a wearable device.

### BACKGROUND

Wearable devices are becoming increasingly common among consumers. These devices, such as a smart watch, are attractive to consumers because they are capable of performing many of the same functions performed by other nonwearable smart devices: text messages, audio calls, schedule keeping, fitness tracking, and financial transactions. The functionalities of wearable devices are in many ways more efficient than those of other smart devices such as cell phones because wearable devices are less cumbersome. For example, a wearable device worn on a user's wrist can remain on the user's person for an extended period of time, whereas a nonwearable device such as a smart phone may be misplaced or forgotten.

Recent advances in wearable device technology have allowed users to perform high risk transactions with their wearable device, such as high value purchases. As another example, users may use their wearable device to confirm their identity for the purpose of entering their apartment, workplace, or other secure area. As technology continues to advance, users will rely more on their wearable device to perform more complex and more high-stakes tasks.

The demand for wearable smart devices is increasing. As wearable device capabilities become more complex, secure methods for performing such capabilities is required. Performing a vulnerable task with a wearable device poses a number of safety risks to a user. For example, a wearable device may be stolen by an unauthorized user and used to purchase expensive items. As another example, an unauthorized user may try to access a user's sensitive personal or business information by accessing the user's wearable device.

These and other deficiencies exist. Therefore, there is a need to provide systems and methods that overcome these deficiencies to verify users in a secure and efficient manner.

### SUMMARY OF THE DISCLOSURE

Aspects of the present disclosure include systems and methods for card emulation on a wearable device. Generally, the following embodiment describe a secure access system and method including a wearable device and a contactless card. As an exemplary embodiment, a user may tap their contactless card to their wearable device thereby allowing the wearable device to emulate the information stored on the contactless card. Through a short communication field, the wearable device and contactless can securely share information with a very small chance of interference from unauthorized parties.

The near field communication (NFC) requires the user to place the physical card in close contact with the wearable device. This requirement improves the security of the exchange of information between the device and the card. Furthermore, it greatly limits the risk of unintentionally sharing sensitive information to unauthorized parties because of the speed of the transaction.

Additionally, an exemplary embodiment for encryption is provided. The method of encryption can be described generally as key diversification where a transmitting device and receiving device are provisioned with the same master key but independently derive a session key necessary to decrypt secret information. This embodiment of encryption improves the security of the systems and methods of the present disclosure.

Embodiments of the present disclosure provide a secure access system between a wearable device and a contactless card, the system comprising: a memory and a processor. The processor is configured to: open a communication field and transmit, upon opening the communication field, an authentication request to a card. The processor can receive, upon transmitting the authentication request, an authentication credential from the card, then validate the authentication credential. Then, the processor can transmit, upon validating the authentication credential, a request for card emulation data and receive, from the card, card emulation data. Then, the processor can store the card emulation data on the memory and emulate the card.

Embodiments of the present disclosure provide a secure access method between a wearable device and a contactless card, the method comprising the steps of: opening a communication field; transmitting, upon opening the communication field, an authentication request to a card; receiving, upon transmitting the authentication request, an authentication credential from the card; validating the authentication credential; transmitting, upon validating the authentication credential, a request for card emulation data; receiving, from the card, card emulation data; storing the card emulation data on the memory; and emulating the card.

Embodiments of the present disclosure provide a non-transitory computer readable medium between a wearable device and a contactless card comprising computer executable instructions that, when executed on a processor, perform steps comprising: opening a communication field, then transmitting, upon opening the communication field, an authentication request to a card; receiving, upon transmitting the authentication request, an authentication credential from the card. Then, the processor can validate the authentication credential and transmit, upon validating the authentication credential, a request for card emulation data. Next, the processor can receive, from the card, card emulation data and store the card emulation data on the memory. Next, the processor can emulate the card.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a block diagram illustrating a system according to an exemplary embodiment.

FIG. 2A is a block diagram illustrating a contactless card according to an exemplary embodiment.

FIG. 2B is a block diagram illustrating a contact pad of a contactless card according to an exemplary embodiment.

FIG. 3 is a diagram illustrating a contactless card and a wearable device according to an exemplary embodiment.

FIG. 4 is a flowchart illustrating a method according to an exemplary embodiment.

FIG. 5 is a flowchart illustrating a cryptography method according to an exemplary embodiment.

FIG. 6 is a flowchart illustrating a sequence according to an exemplary embodiment.

FIG. 7 is a flowchart illustrating a sequence according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner and the features, advantages, and characteristics of any embodiment can be interchangeably combined with the features, advantages, and characteristics or any other embodiment. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many user devices can emulate cards to complete transactions. For example, smart mobile devices can emulate credit or debit cards to pay for a coffee at a kiosk. Thus, card emulation allows users to pay for goods and services without the need to carry their physical card. However, handheld user devices such as mobile devices, laptops, or tablets can be too cumbersome or too easily misplaced. Thus, the present embodiments offer a solution: user authentication and card emulation on a wearable device.

The present embodiments describe a system and method for authenticating a user via a wearable device and a card. The wearable device can open a communication field such as a near field communication (NFC) field. Then, the user can move their contactless card into the communication field near the wearable device. The card can transmit an authentication credential to the wearable device. Having authenticated the user, the wearable device can then request card emulation data from the card. Card emulation data can include, as a nonlimiting example, payment information, expiration data, and a security code. The card can transmit the emulation data to the wearable device, and the wearable device can store the emulation data in its memory. Thus, the user can emulate the card for payments.

To add another layer of security, the wearable device can automatically de-sync from the card emulation data when the device is removed from the user. For example, the user can remove the wearable device when they arrive home from work. Upon being removed, the wearable device stops emulating the card. To restart the emulation, the user can perform the authentication again. This allows for the user to quickly and safely de-sync and re-sync the wearable device with the card emulation data.

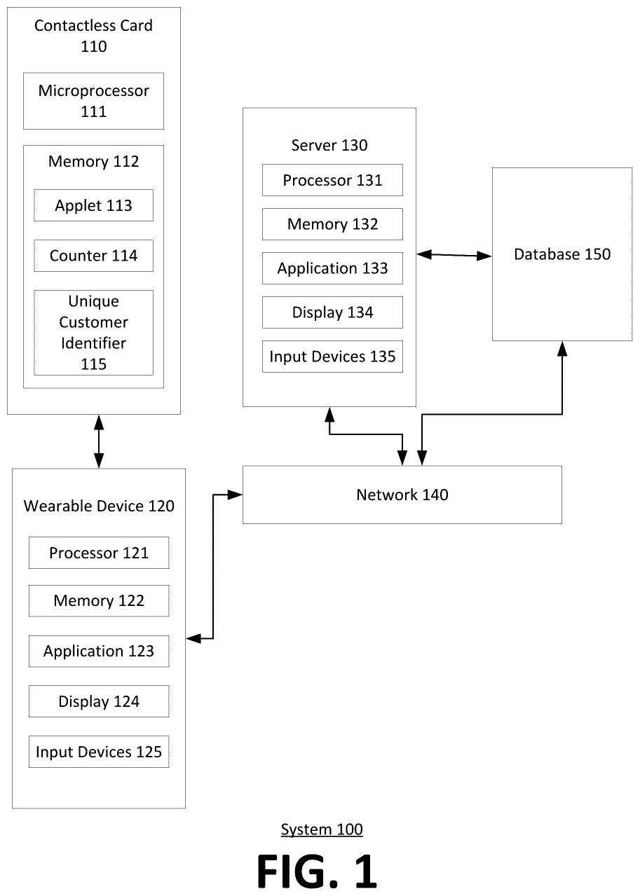

FIG. 1 is a diagram illustrating a system 100 according to an exemplary embodiment. The system 100 may comprise a contactless card 110, a wearable device 120, a server 130, a network 140, and a database 150.

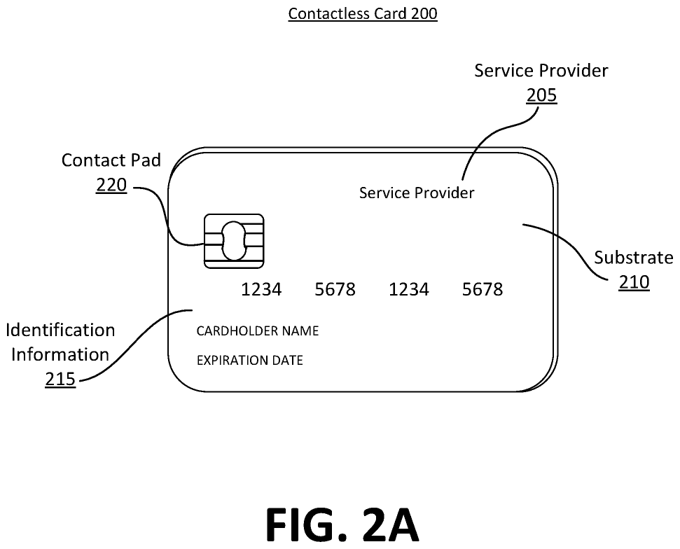

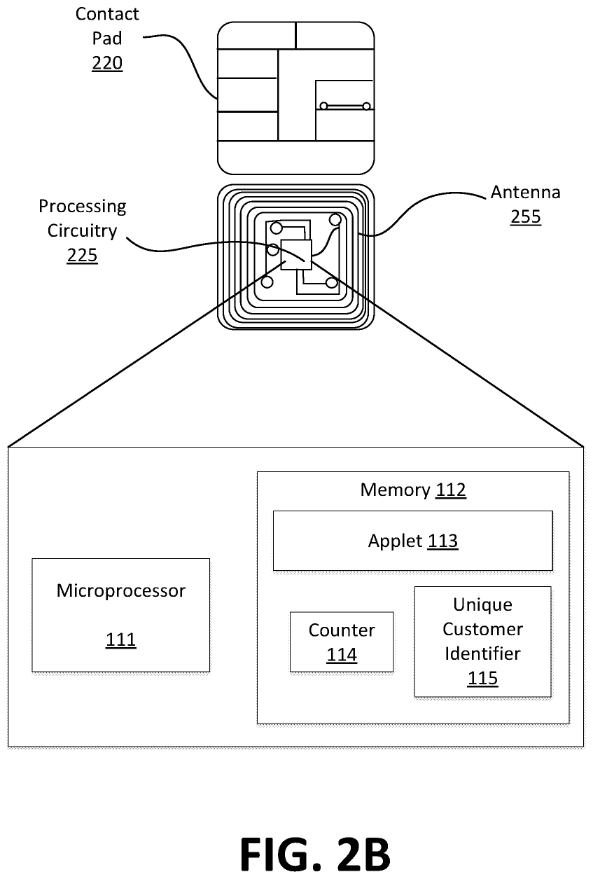

System 100 may include one or more contactless cards 110 which are further explained below with reference to FIGS. 2A and 2B. In some embodiments, contactless card 110 may be in wireless communication, utilizing NFC in an example, with wearable device 120 and/or server 130.

System 100 may include a wearable device 120. The wearable device 120 may be a computer-enabled wearable device. Exemplary computer-enabled wearable devices include, without limitation, an Apple Watch® or any other wearable device running Apple's iOS® operating system, Garmin Vivoactive® or any other computer-enabled wearable device produced by Garmin, Fitbit Versa® or any other computer-enabled wearable device produced by Fitbit, Samsung Galaxy Watch® or any other computer-enabled wearable device produced by Samsung, or any other computer-enabled wearable device running Google's Android® operating system. As further examples, a computer-enabled wearable device can include, without limitation, a computer-enabled watches, computer-enabled wristbands, computer-enabled glasses, computer-enabled jewelry, computer-enabled clothing, and implantable computer-enabled devices.

The wearable device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the wearable device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the wearable device 120. In some examples, the wearable device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The wearable device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the wearable device 120 that is available and supported by the wearable device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition, or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2A illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, such as a user device, smart phone, laptop, desktop, smart watch, some other wearable device, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the card (not shown in FIG. 2A).

FIG. 2B illustrates a contact pad of a contactless card according to an example embodiment.

As illustrated in FIG. 2B, the contact pad 220 may include processing circuitry 225 for storing and processing information, including a microprocessor 111 and a memory 112. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 112 may be a read-only memory, write-once read-multiple memory or read/write memory, e.g., RAM, ROM, and EEPROM, and the contactless card 200B may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 112 may be configured to store one or more applets 113, one or more counters 114, and a customer identifier 115. The one or more applets 113 may comprise one or more software applications configured to execute on one or more contactless cards, such as Java Card applet. However, it is understood that applets 113 are not limited to Java Card applets, and instead may be any software application operable on contactless cards or other devices having limited memory. The one or more counters 114 may comprise a numeric counter sufficient to store an integer. The customer identifier 115 may comprise a unique alphanumeric identifier assigned to a user of the contactless card 110, and the identifier may distinguish the user of the contactless card from other contactless card users. In some examples, the customer identifier 115 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 220 or entirely separate from it, or as further elements in addition to processor 111 and memory 112 elements located within the contact pad 220.

In some examples, the contactless card 110 may comprise one or more antennas 255. The one or more antennas 255 may be placed within the contactless card 110 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 110 may act as the secondary of an air core transformer. The terminal may communicate with the contactless card 110 by cutting power or amplitude modulation. The contactless card 110 may infer the data transmitted from the terminal using the gaps in the contactless card's power connection, which may be functionally maintained through one or more capacitors. The contactless card 110 may communicate back by switching a load on the contactless card's coil or load modulation. Load modulation may be detected in the terminal's coil through interference.

As explained above, the contactless cards 110 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

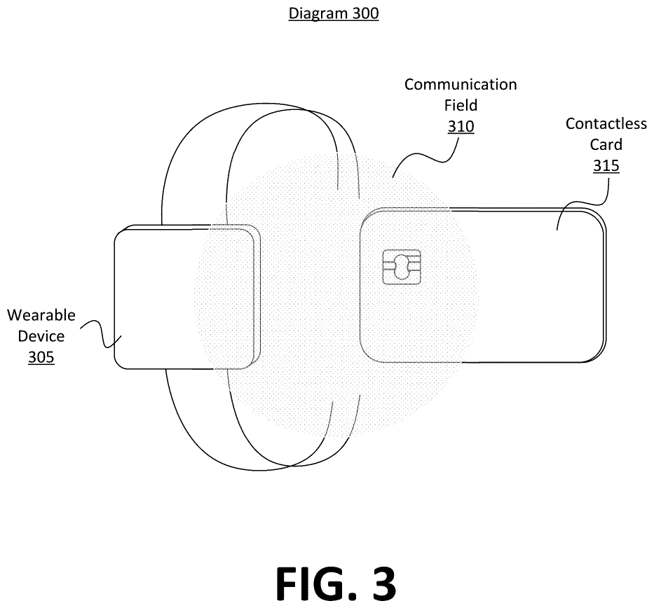

FIG. 3 is a diagram illustrating a wearable device in a communication field with a contactless card according to an exemplary embodiment.

The diagram 300 illustrates a wearable device 305, a communication field 310, and a contactless card 315. The wearable device 305 can include a wearable smart device such as a smart watch. Wearable devices are discussed further with reference to FIG. 1. The communication field 305 can include Bluetooth, NFC, Radio Frequency Identification (RFID), Wi-Fi, and/or the like. The contactless card 315 is further explained with reference to FIGS. 2A and 2B.

The wearable device 305 enter a communication field 310. The communication field 310 can be opened in response to a request from the card, from a server, or from another user device or merchant device. As another nonlimiting example, the communication field 310 can open in response to the wearable device 305 coming into close proximity with the contactless card 315. Then, a user may place the contactless card 315 within the communication field 305. Once the wearable device 305 and the contactless card 315 are within the communication field 310, the wearable device 305 can verify the user's identity with one or more authentication credentials from the contactless card 315. Additionally, the contactless card 315 can transmit card emulation data to the wearable device 305. Without limitation, data and/or an applet stored on the contactless card 315 can be transmitted to the wearable device 305. The data and/or applet can be stored in the memory of the wearable device 305. With the data and/or applet stored on the wearable device 305, the wearable device 305 can emulate the contactless card 315 for a transaction. The emulation can be achieved by the wearable device 305's processor, a processor associated with a server, or some other processor.

Although diagram 300 illustrates only one contactless card, it is understood that the wearable device 305 can interact with a plurality of contactless cards. The wearable device 305 can emulate one or more contactless cards 315 via emulation data transferred over the communication field 310.

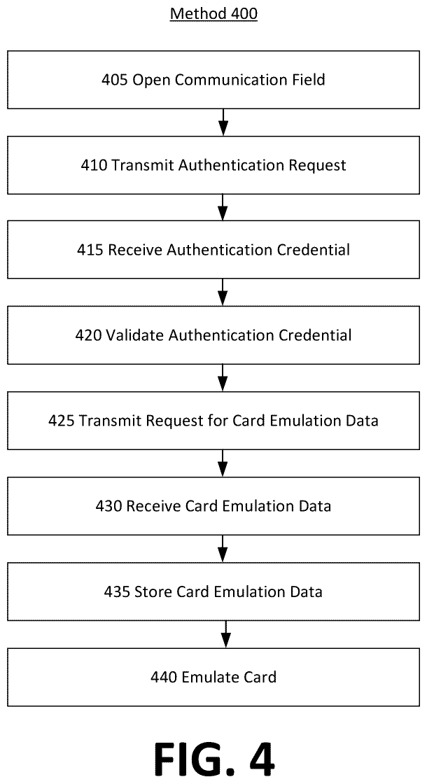

FIG. 4 is a flowchart illustrating a method 400 according to an exemplary embodiment.

The method 400 can begin with action 405 in which a wearable device can open a communication field. This action can be performed by a processor associated with the wearable device. The communication field can be opened in response to a request from a server, a different user device or wearable device, or a merchant device. The open communication field can include Bluetooth, NFC, Radio Frequency Identification (RFID), Wi-Fi, and/or the like. In other embodiments, the processor associated with the wearable device can open the communication field in response to being in close proximity to one or more contactless cards. In other embodiments, the communication field can be opened in response to a command entered by the user through one or more software applications on the wearable device.

In action 410, an authentication request can be transmitted to a contactless card. This action can be performed by a processor associated with wearable device. The processor may be associated with a separate server. The authentication request serves to authenticate the identity of the user. It is understood that other one or more authentication request can be sent, and that different authentication credentials may be requested such as a biometric, a password, a personal identification number (PIN), or some other multi-factor authentication.

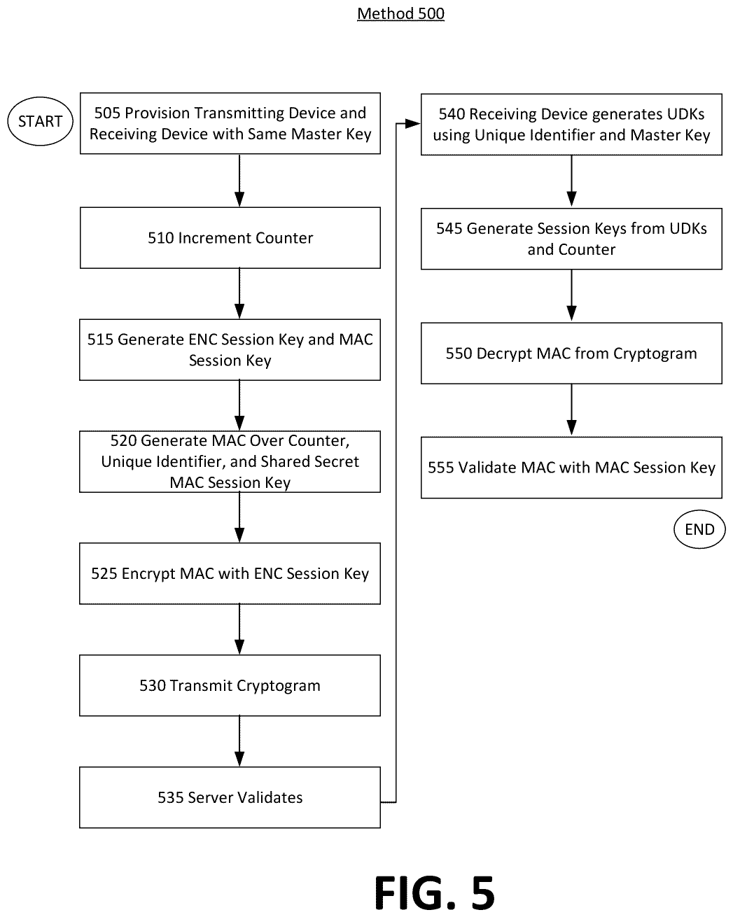

In action 415, the wearable device can receive an authentication credential from the contactless card. The contactless card can transmit the authentication credential over the communication field. The authentication credential can be configured to satisfy the authentication request. The authentication credential can include without limitation a unique customer identifier, a counter value, or some other unique information. In some embodiments, the authentication credential can be an encrypted message authentication code (MAC), in which case the contactless card and the wearable device would perform a diversified key exchange. The diversified key exchange is discussed with further reference to FIG. 5. In action 420, the authentication credential is validated. This action can be performed by the wearable device or the server.

In action 425, a request for card emulation data can be transmitted to the contactless card. This action can be performed by a processor associated with the wearable device or server. The request for card emulation data can be sent over the communication field. In some embodiments, the wearable device may preserve the same communication field from actions 405-430. In other embodiments, the wearable device may open a first communication field for receiving the authentication credential, then close the first communication field, then open a second communication field to receive the card emulation data. In other embodiments, the wearable device can transmit the request for card emulation data to the server over a wireless network.

In action 430, the wearable device can receive the card emulation data. The card emulation data can be transmitted directly from the contactless card. In other embodiments, the wearable device can receive the card emulation data from a server. The card emulation data can include without limitation a primary account number (PAN), card verification value (CVV), security code, expiration data, cardholder name, and service provider. Having received the card emulation data, the wearable device in action 435 can store the card emulation data in its memory. This action can be performed by the process associated with the wearable device. In action 440, the wearable device can emulate the card via the card emulation data. In some embodiments, the wearable device can emulate the card to complete a consumer transaction, open a locker, or otherwise complete a payment or secure verification of the user's identity. It is understood that, in other embodiments, the transaction can include without limitation: accessing a secure area such as a house or abode, a car, a locker, a place of employment, a safe, a storage unit, or other secure area; depositing or withdrawing funds or other transaction performed at an ATM, bank, or other financial institution; making a consumer purchase; paying for a service; checking into a reservation associated with a restaurant, dining experience, entertainment service, tour, or some other consumer experience.

FIG. 5 is a flow chart of method 500 of key diversification according to an example of the present disclosure.

In some examples, a sender and recipient may desire to exchange data via a transmitting device and a receiving device. In some embodiments, the transmitting device is the contactless card, and the receiving device is the wearable device and/or the server. As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like. The transmitting device and the receiving device may be network-enabled computer devices. In some examples, the transmitting device may comprise a contactless card and the receiving device may comprise a server. In other examples, the receiving device may comprise a user device or a user device application.

The method 500 can begin with step 505. In step 505, a transmitting device and receiving device may be provisioned with the same master key, such as the same master symmetric key. When the transmitting device is preparing to process the sensitive data with symmetric cryptographic operation, the transmitting device may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In step 510, the transmitting device may take the selected cryptographic algorithm, and using the master symmetric key, process the counter value 114. For example, the sender may select a symmetric encryption algorithm, and use a counter which updates with every conversation between the transmitting device and the receiving device The counter 114 may comprise a numeric counter sufficient to store an integer. The transmitting device may increment the counter one or more times. In step 515, the transmitting device generates two session keys: one ENC (encryption) session key and one MAC (message authentication code) session key. The transmitting device may encrypt the counter value with the selected symmetric encryption algorithm using the master symmetric key to create a session key.

In step 520, the transmitting device generates the MAC over the counter 114, the unique customer identifier 340, and the shared secret MAC session key. The customer identifier 115 may comprise a unique alphanumeric identifier assigned to a user of the contactless card, and the identifier may distinguish the user of the contactless card from other contactless card users. In some examples, the customer identifier 115 may identify both a customer and an account assigned to that customer and may further identify the contactless card associated with the customer's account.

In step 525, the transmitting device encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In step 530, the transmitting device transmits a cryptogram to the receiving device. The cryptogram can include the applet information 113, the unique customer identifier 115, the counter value 114, and the encrypted MAC. In step 535, the receiving device validates the cryptogram. In action 540, the receiving device generates its own UDKs (unique diversified keys) using the unique customer identifier 115 and the master key. The unique customer identifier is derived from the validated cryptogram. Recall that the receiving device has already been provisioned with the master key.

In action 545, the receiving device generates two session keys: one ENC (encryption) session key and one MAC (message authentication code) session key. The receiving device may generate these session keys from the UDKs and the counter value. The counter value can be derived from the cryptogram.

In action 550, the receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

In action 555, the receiving device validates the MAC with the MAC session key generated in action 515. The receiving device may validate the MAC over the unique customer identifier and the counter value.

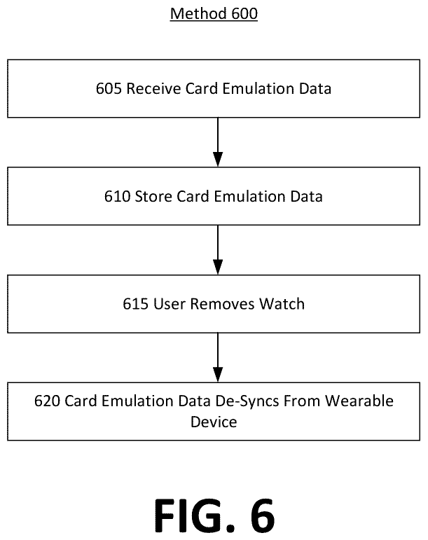

In FIG. 6, Method 600 describes the de-syncing of the wearable device according to an exemplary embodiment.

In action 605, the wearable device can receive card emulation data. The card emulation data can be received from the contactless card, the server, or some other user device. In action 610, the wearable device can store the card emulation data in its memory.

In action 615, the user removes the wearable device from their immediate person. Upon being removed, the wearable device in action 620 can de-sync from the card emulation. This ensures that the wearable device cannot emulate the card upon being removed from the user. In other embodiments, the wearable device may de-sync from the user or from the card emulation data by other means, including without limitation: the passing of a predetermined amount of time; a predetermined number of transactions has been performed by the wearable device; an expensive transaction is being attempted; and/or a certain predetermined transaction is being attempted.

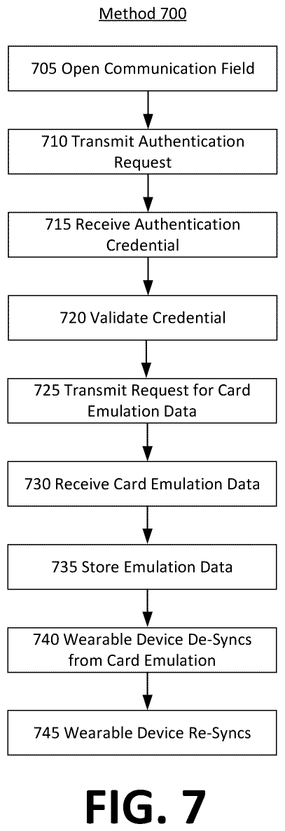

FIG. 7 is a flowchart illustrating a method 700 according to an exemplary embodiment.

The method 700 can begin with action 705 in which the wearable device can open a communication field. This action can be performed by a processor associated with the wearable device. The communication field can be opened in response to a request from a server, a different user device or wearable device, or a merchant device. The open communication field can include Bluetooth, NFC, Radio Frequency Identification (RFID), Wi-Fi, and/or the like. In other embodiments, the processor associated with the wearable device can open the communication field in response to being in close proximity to one or more contactless cards. In other embodiments, the communication field can be opened in response to a command entered by the user through one or more software applications on the wearable device.

In action 710, an authentication request can be transmitted to the contactless card. This action can be performed by a processor associated with wearable device. The processor may be associated with a separate server. The authentication request serves to authenticate the identity of the user. It is understood that other one or more authentication request can be sent, and that different authentication credentials may be requested such as a biometric, a password, a PIN, or some other multi-factor authentication.

In action 715, the wearable device can receive an authentication credential from the contactless card. The contactless card can transmit the authentication credential over the communication field. The authentication credential can be configured to satisfy the authentication request. The authentication credential can include without limitation a unique customer identifier, a counter value, or some other unique information. In some embodiments, the authentication credential can be an encrypted message authentication code (MAC), in which case the contactless card and the wearable device would perform a diversified key exchange. The diversified key exchange is discussed with further reference to FIG. 5.

In action 720, the authentication credential is validated. This action can be performed by the wearable device or the server. For example, the wearable device can transmit the authentication credential over a wireless network to the server, then the server can validate the credential, then the server can return a validation message to the user device.

In action 725, a request for card emulation data can be transmitted to the contactless card. This action can be performed by a processor associated with the wearable device or server. The request for card emulation data can be sent over the communication field. In some embodiments, the wearable device may preserve the same communication field from actions 705-730. In other embodiments, the wearable device may open a first communication field for receiving the authentication credential, then close the first communication field, then open a second communication field to receive the card emulation data. In other embodiments, the wearable device can transmit the request for card emulation data to the server over a wireless network.

In action 730, the wearable device can receive the card emulation data. The card emulation data can be transmitted directly from the contactless card. In other embodiments, the wearable device can receive the card emulation data from a server. The card emulation data can include without limitation a primary account number (PAN), card verification value (CVV), security code, expiration data, cardholder name, and service provider.

Having received the card emulation data, the wearable device in action 735 can store the card emulation data in its memory. This action can be performed by the process associated with the wearable device. The wearable device can emulate the card via the card emulation data. In some embodiments, the wearable device can emulate the card to complete, without limitation, a consumer transaction, withdraw or deposit cash, open a locker, and/or otherwise complete a payment or secure verification of the user's identity. The wearable device can emulate the card using the card's applet. Applets may be added to contactless cards to provide an OTP for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

In action 740, the wearable device can de-sync from card emulation. The de-sync can happen as a consequence of one or more actions, including without limitation: taking the wearable device off of the user; the passing of a predetermined amount of time; the wearable device leaving a certain geographic area; the card emulation reaching a certain number of uses, transactions, or payments; and a manual de-syncing of the card via one or more software applications on one or more user devices. These nonlimiting example are referred to as desyncing events. The wearable device can be configured to de-sync only when taken off from the user. In other words, the wearable device can be configured to remain synced with the user and/or card emulation data as long as the wearable device is worn by the user.

In action 745, the wearable device can resync to the card emulation data. The resyncing can require a re-authentication of the user, including without limitation one or more different authentication credentials such as an OTP, biometric, PIN, password, or other authentication factor. It is understood that these factors may also be used for the first authentication credential. The need to re-authenticate the user to resync the card emulation data ensures the security of the wearable device.

In some aspects, the techniques described herein relate to a secure access system between a wearable device and a contactless card, the system including: a memory; and a processor, wherein the processor is configured to: open a communication field; transmit, upon opening the communication field, an authentication request to a card; receive, upon transmitting the authentication request, an authentication credential from the card; validate the authentication credential; transmit, upon validating the authentication credential, a request for card emulation data; receive, from the card, card emulation data; store the card emulation data on the memory; and emulate the card.

In some aspects, the techniques described herein relate to a system, wherein the wearable device is a smart watch.

In some aspects, the techniques described herein relate to a system, wherein the wearable device can perform a transaction with the card emulation data, the transaction including at least one selected from the group of a transaction associated with an automatic telling machine (ATM), bank, or other financial institution.

In some aspects, the techniques described herein relate to a system, wherein the transaction is one or more security transactions at a place of business, an abode, or other private institution.

In some aspects, the techniques described herein relate to a system, wherein the wearable device continues to emulate card information as long as the wearable devices remains worn.

In some aspects, the techniques described herein relate to a system, wherein the wearable device is further configured to retain the card information after the wearable device has been de-synced from a user.

In some aspects, the techniques described herein relate to a secure access method between a wearable device and a contactless card, the method including the steps of: opening a communication field; transmitting, upon opening the communication field, an authentication request to a card; receiving, upon transmitting the authentication request, an authentication credential from the card; validating the authentication credential; transmitting, upon validating the authentication credential, a request for card emulation data; receiving, from the card, card emulation data; storing the card emulation data on the memory; and emulating the card.

In some aspects, the techniques described herein relate to a method, wherein the authentication credential is at least one selected from the group of a unique customer identifier and a counter value.

In some aspects, the techniques described herein relate to a method, wherein the card emulation data includes at least one selected from the group of a primary account number (PAN), a card verification value (CVV), and a security code.

In some aspects, the techniques described herein relate to a method, wherein the card emulation is performed via a software application associated with the processor.

In some aspects, the techniques described herein relate to a method, wherein the communication field includes at least one selected from the group of a near communication field (NFC), Bluetooth, and a radio frequency identification (RFID) field.

In some aspects, the techniques described herein relate to a method, wherein the method further includes the steps of: desyncing, upon one or more predetermined desyncing events occurring, the wearable device from the card emulation.

In some aspects, the techniques described herein relate to a non-transitory computer readable medium containing computer executable instructions that, when executed by a wearable device including a processor, configure the computer hardware arrangement to perform procedures including: opening a communication field; transmitting, upon opening the communication field, an authentication request to a card; receiving, upon transmitting the authentication request, an authentication credential from the card; validating the authentication credential; transmitting, upon validating the authentication credential, a request for card emulation data; receiving, from the card, card emulation data; storing the card emulation data on the memory; and emulating the card.

In some aspects, the techniques described herein relate to a non-transitory computer readable medium, wherein the computer wearable device is a smart watch.

In some aspects, the techniques described herein relate to a non-transitory computer readable medium, wherein the procedures further include the step of performing one or more financial transactions at an automated teller machine (ATM), bank, or other financial institution.

In some aspects, the techniques described herein relate to a non-transitory computer readable medium, wherein the procedures further include the step of performing one or more security transactions at a place of business, an abode, or other private institution.

In some aspects, the techniques described herein relate to a non-transitory computer readable medium, wherein the validation of the authentication credential includes: transmitting, by the wearable device to one or more servers, the authentication credential, and receiving, by the wearable device from the one or more servers, a validation message indicating that the authentication credential has been validated.

In some aspects, the techniques described herein relate to a non-transitory computer readable medium, wherein the procedures further include the step of the wearable device continuing to emulate card information as long as the wearable devices remains worn.

In some aspects, the techniques described herein relate to a non-transitory computer readable medium, wherein the procedures further include the step of retaining the card information after the wearable device has been de-synced from a user.

In some aspects, the techniques described herein relate to a non-transitory computer readable medium, wherein the procedures further include the steps of re-syncing the wearable device.

Having stored the card emulation data in action 735, the wearable device can simply retrieve the card emulation data when the user wants to resync the wearable device. In other embodiments, the wearable device may nonetheless want to retrieve the card emulation data from a server or some other user device.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A secure access system between a wearable device and a contactless card, the system comprising:
a memory; and
a processor, wherein the processor is configured to:
open a communication field;
transmit, upon opening the communication field, an authentication request to a card;
receive, upon transmitting the authentication request, an authentication credential from the card;
validate the authentication credential;
transmit, upon validating the authentication credential, a request for card emulation data;
receive, from the card, card emulation data;
store the card emulation data on the memory; and
emulate the card.

2. The system of claim 1, wherein the wearable device is a smart watch.

3. The system of claim 1, wherein the wearable device can perform a transaction with the card emulation data, the transaction comprising at least one selected from the group of a transaction associated with an automatic telling machine (ATM), bank, or other financial institution.

4. The system of claim 3, wherein the transaction is one or more security transactions at a place of business, an abode, or other private institution.

5. The system of claim 1, wherein the wearable device continues to emulate card information as long as the wearable devices remains worn.

6. The system of claim 1, wherein the wearable device is further configured to retain the card information after the wearable device has been de-synced from a user.

7. A secure access method between a wearable device and a contactless card, the method comprising the steps of:
opening a communication field;
transmitting, upon opening the communication field, an authentication request to a card;
receiving, upon transmitting the authentication request, an authentication credential from the card;
validating the authentication credential;
transmitting, upon validating the authentication credential, a request for card emulation data;
receiving, from the card, card emulation data;
storing the card emulation data on the memory; and
emulating the card.

8. The method of claim 7, wherein the authentication credential is at least one selected from the group of a unique customer identifier and a counter value.

9. The method of claim 7, wherein the card emulation data comprises at least one selected from the group of a primary account number (PAN), a card verification value (CVV), and a security code.

10. The method of claim 7, wherein the card emulation is performed via a software application associated with the processor.

11. The method of claim 7, wherein the communication field comprises at least one selected from the group of a near communication field (NFC), Bluetooth, and a radio frequency identification (RFID) field.

12. The method of claim 7, wherein the method further comprises the steps of:
desyncing, upon one or more predetermined desyncing events occurring, the wearable device from the card emulation.

13. A non-transitory computer readable medium containing computer executable instructions that, when executed by a wearable device comprising a processor, configure the computer hardware arrangement to perform procedures comprising:
opening a communication field;
transmitting, upon opening the communication field, an authentication request to a card;
receiving, upon transmitting the authentication request, an authentication credential from the card;
validating the authentication credential;
transmitting, upon validating the authentication credential, a request for card emulation data;
receiving, from the card, card emulation data;
storing the card emulation data on the memory; and
emulating the card.

14. The non-transitory computer readable medium of claim 13, wherein the computer wearable device is a smart watch.

15. The non-transitory computer readable medium of claim 13, wherein the procedures further comprise the step of performing one or more financial transactions at an automated teller machine (ATM), bank, or other financial institution.

16. The non-transitory computer readable medium of claim 13, wherein the procedures further comprise the step of performing one or more security transactions at a place of business, an abode, or other private institution.

17. The non-transitory computer readable medium of claim 13, wherein the validation of the authentication credential comprises:
transmitting, by the wearable device to one or more servers, the authentication credential, and
receiving, by the wearable device from the one or more servers, a validation message indicating that the authentication credential has been validated.

18. The non-transitory computer readable medium of claim 13, wherein the procedures further comprise the step of the wearable device continuing to emulate card information as long as the wearable devices remains worn.

19. The non-transitory computer readable medium of claim 13, wherein the procedures further comprise the step of retaining the card information after the wearable device has been de-synced from a user.

20. The non-transitory computer readable medium of claim 19, wherein the procedures further comprise the steps of re-syncing the wearable device.
